(19) United States
(12) Patent Application Publication
(10) Pub. No.: US 2010/0079861 A1
(43) Pub. Date: Apr. 1, 2010

(54) Exit Pupil Forming Scanned Beam Projection Display Having Higher Uniformity

(75) Inventor: Karlton D. Powell, Lake Stevens, WA (US)

Correspondence Address: MICROVISION, INC., 6222 185TH AVENUE NE, REDMOND, WA, 98052, US

(73) Assignee: MICROVISION, INC., Redmond, WA (US)

(21) Appl. No.: 12/240,161

(22) Filed: Sep. 29, 2008

(51) Int. Cl. G03B 21/60

(52) U.S. Cl. 359/449; 359/455; 359/451

(57) ABSTRACT

Briefly, in accordance with one or more embodiments, a display screen for a scanned beam display system comprises an exit pupil expander comprising a reflective layer to reflect an incoming beam from a scanned beam projector to an eyebox. Exit numerical aperture cones emanating from the exit pupil expander resulting from the reflected incoming beam are angularly redirected toward an eyebox disposed near an image plane to result in at least partially overlapping zeroth-order diffraction pattern from multiple spots on the exit pupil expander.

### BACKGROUND

Flat screens used in scanned-beam display projectors typically suffer in resulting uniformity due to the fact that the zero^{th}-orders (0^{th}-order) of diffracted light, typically defined by specular reflection angles, emanating from each spot position on the screen never cross as they propagate toward the viewing plane. Even flat screens having redirection properties may suffer from this limitation due to the z-phase-shift of scatter center origins, and the fact that the scanned beam has a point origin prior to reflection. Further, this lack of zero^{th}-order crossover at the eye results in the eye capturing different angular portions of the exit diffraction pattern for the continuum of spot positions, or field points across the screen. The result is that the eye sees an intensity modulation mapped across the screen field of view (FOV) in the form of the diffraction pattern convolved with the eye pupil, and this modulation pattern will scale with viewing distance. For the case of a periodic screen, the pattern is a direct result of the diffraction pattern, or beamlet pattern, appearing to be wrapped across the FOV, also known as apparent beamlet wrapping. In addition, significant tilting of the screen may further distort this modulation pattern.

### DESCRIPTION OF THE DRAWING FIGURES

Claimed subject matter is particularly pointed out and distinctly claimed in the concluding portion of the specification. However, such subject matter may be understood by reference to the following detailed description when read with the accompanying drawings in which:

FIG. 1 is a diagram of a scanned beam display system in accordance with one or more embodiments;

FIG. 2 is a diagram of a projection display system including a display screen having an ellipsoidal surface and an elliptical profile to provide higher uniformity in accordance with one or more embodiments;

FIG. 3 is a diagram of a projection display system including a pseudo-retroreflecting display screen to provide higher efficiency into the viewing eyebox and higher uniformity in accordance with one or more embodiments;

FIGS. 4A and 4B are diagrams of the pseudo-retroreflecting display screen of FIG. 3 illustrating the redirection of the exit numerical aperture exit cones in accordance with one or more embodiments;

FIG. 5 is a diagram of a projection display system having a planar display screen illustrating the redirection of the exit numerical aperture exit cones in accordance with one or more embodiments;

FIG. 6 is a diagram of the planar display screen of FIG. 5 having a prismatic array to provide redirection of the exit numerical aperture exit cones in accordance with one or more embodiments

FIGS. 7A and 7B are diagrams illustrating a cylindrical profile of a Fresnel reflector of a planar display screen to provide redirection of the exit numerical aperture exit cones in accordance with one or more embodiments;

FIGS. 8A, 8B, 8C, and 8D are diagrams illustrating a spherical profile of a Fresnel reflector of a planar display screen to provide redirection of the exit numerical aperture exit cones in accordance with one or more embodiments;

FIGS. 9A-9C are diagrams of a generally planar display screen for a scanned beam display system comprising a double sided microlens array (MLA) having one side reflective to provide redirection of the exit numerical aperture exit cones in accordance with one or more embodiments;

FIGS. 10A-10C are diagrams of a generally planar display screen for a scanned beam display system comprising a microlens array and a prismatic or Fresnel reflector to provide redirection of the exit numerical aperture exit cones in accordance with one or more embodiments;

FIGS. 11A-11D are diagrams of a generally planar display screen for a scanned beam display system comprising a diffuser and a prismatic or Fresnel reflector in accordance with one or more embodiments; and

FIG. 12 is a diagram of a projection display system including an exit-pupil-forming direct-view display screen to provide higher efficiency into the viewing eyebox and higher uniformity in accordance with one or more embodiments.

It will be appreciated that for simplicity and/or clarity of illustration, elements illustrated in the figures have not necessarily been drawn to scale. For example, the dimensions of some of the elements may be exaggerated relative to other elements for clarity. Further, if considered appropriate, reference numerals have been repeated among the figures to indicate corresponding and/or analogous elements.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, well-known methods, procedures, components and/or circuits have not been described in detail.

In the following description and/or claims, the terms coupled and/or connected, along with their derivatives, may be used. In particular embodiments, connected may be used to indicate that two or more elements are in direct physical and/or electrical contact with each other. Coupled may mean that two or more elements are in direct physical and/or electrical contact. However, coupled may also mean that two or more elements may not be in direct contact with each other, but yet may still cooperate and/or interact with each other. For example, “coupled” may mean that two or more elements do not contact each other but are indirectly joined together via another element or intermediate elements. Finally, the terms “on,” “overlying,” and “over” may be used in the following description and claims. “On,” “overlying,” and “over” may be used to indicate that two or more elements are in direct physical contact with each other. However, “over” may also mean that two or more elements are not in direct contact with each other. For example, “over” may mean that one element is above another element but not contact each other and may have another element or elements in between the two elements. Furthermore, the term “and/or” may mean “and”, it may mean “or”, it may mean “exclusive- or”, it may mean “one”, it may mean “some, but not all”, it may mean “neither”, and/or it may mean “both”, although the scope of claimed subject matter is not limited in this respect. In the following description and/or claims, the terms “comprise” and “include,” along with their derivatives, may be used and are intended as synonyms for each other.

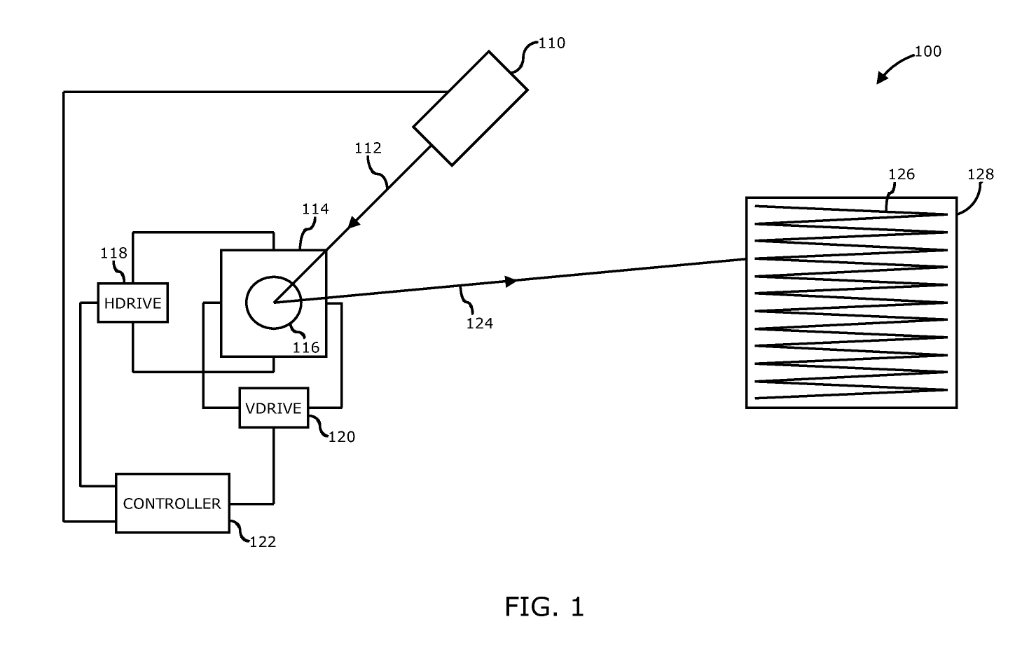

Referring now to FIG. 1, a diagram of a scanned beam display system in accordance with one or more embodiments will be discussed. Although FIG. 1 illustrates a scanned beam display system for purposes of discussion, it should be noted that a scanned beam imaging system, other types of imaging systems may be utilized in one or embodiments, and/or alternatively imaging systems such as a bar code scanner or digital camera could likewise be utilized in accordance with one or more embodiments, and the scope of the claimed subject matter is not limited in this respect. As shown in FIG. 1, scanned beam display 100, or projector, comprises a light source 110, which may be a laser light source such as a laser or the like, capable of emitting a beam 112 which may comprise a laser beam. In some embodiments, light source may comprise two or more light sources, such as in a color system having red, green, and blue light sources, wherein the beams from the light sources may be combined into a single beam. The beam 112 impinges on a scanning platform 114 which may comprise a microelectromechanical system (MEMS) based scanner or the like, and reflects off of scanning mirror 116 to generate a controlled output beam 124. In one or more alternative embodiments, scanning platform 114 may comprise a diffractive optic grating, a moving optic grating, a light valve, a rotating mirror, a spinning silicon device, a flying spot projector, or other similar scanning devices or moving light projecting devices, and the scope of the claimed subject matter is not limited in this respect. A horizontal drive circuit 118 and/or a vertical drive circuit 120 modulate the direction in which scanning mirror 116 is deflected to cause output beam 124 to generate a scanned beam 126, thereby creating a displayed image 128, for example on a projection surface and/or image plane. Although scanned beam 126 may comprise a raster scan as shown in FIG. 1 as an example in one particular embodiment, the projected image need not be limited to a raster scan wherein other scanned beam patterns may likewise be utilized, and the scope of the claimed subject matter is not limited in this respect. In general, any scanned beam image may be generated. A display controller 122 controls horizontal drive circuit 118 and vertical drive circuit 120 by converting pixel information of the displayed image into laser modulation synchronous to the scanning platform 114 to write the image information as displayed image 128 based upon the position of the output beam 124 in scanned beam 126 and/or any scanned beam pattern, and the corresponding intensity and/or color information at the corresponding pixel in the image. Display controller 122 may also control other various functions of scanned beam display 100.

In one or more embodiments, for two dimensional scanning to generate or capture a two dimensional image, a fast scan axis may refer to the horizontal direction of scanned beam 126 and the slow scan axis may refer to the vertical direction of scanned beam 126. Scanning mirror 116 may sweep the output beam 124 horizontally at a relatively higher frequency and also vertically at a relatively lower frequency. The result is a scanned trajectory of laser beam 124 to result in scanned beam 126, and/or generally any scanned beam pattern. However, the scope of the claimed subject matter is not limited in these respects.

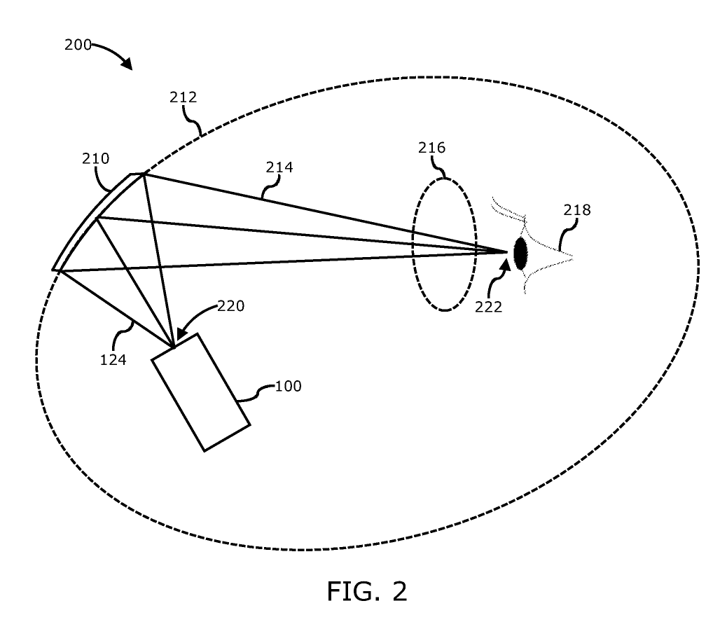

Referring now to FIG. 2, a diagram of a projection display system including a display screen having an elliptical profile to provide higher uniformity in accordance with one or more embodiments will be discussed. As shown in FIG. 2, projection display system 200 comprises a scanned beam display 100 capable of emitting output beams 124 onto a display screen 210 which in turn redirects the reflected beams 214 into an eyebox 216 in which the viewer's eye 218 can observe the image projected by scanned beam display 100. In the embodiment shown in FIG. 2, display screen 210 may have an elliptical profile generally defined by ellipse or ellipsoid 212 wherein the elliptical shape of display screen 210 is capable of generally directing the reflected beams to be redirected into a relatively smaller sized eyebox 216 to result in higher gain and/or uniformity in the displayed image as compared to a basic planar shaped display screen, which typically does not have redirection properties. In one or more embodiments, scanned beam display 100 is disposed at or near a first focus 220 of ellipse 212, and the viewer's eye 218 is designed to be disposed at or near a second focus 222 of ellipse 212. In one or more embodiments, display screen 210 comprises a reflective exit pupil expander (EPE) to form a desired exit pupil in eyebox 216. Such an exit pupil forming display screen 210 may comprise a microlens array (MLA) having at least partially reflective properties. The pitch of the MLA of display screen 210 may be selected at each position across display screen 210 so as to maintain a ratio of beam size to diffraction order spacing at the viewing plane. The dynamic moiré spot-to-pitch relationships may also be selected to provide higher uniformity and to limit moiré and/or tiling coherent artifacts.

In one or more embodiments, the elliptical profile of display screen 210 may be utilized to minimize beamlet wrapping, which lowers visible tiling density, by overlapping all diffraction pattern zero^{th}-orders at the viewing plane emanating from all spot positions on display screen 210. In general, the geometry and spacing of the viewer's eye with respect to display screen 210 and scanned beam display 100 will define the foci 220 and 222 of ellipsoid 212 which will define the needed elliptical profile of display screen 210. In the embodiment shown in FIG. 2, the ellipsoidal shape of display screen 210 increases efficiency of the displayed image due to exit pupil formation in comparison with a flat display screen which would be non-exit-pupil forming. In such an off-axis geometrical arrangement using a flat display screen instead of display screen 210, the zero^{th}-orders would never cross even if display screen is designed to have position-dependent redirection properties. In general, the surface section parameters may be adjusted with variations in the ellipsoidal shape of display screen 210 for further optimization. Typically, a display screen 210 having a periodic MLA may function to provide higher uniformity with fewer coherent artifacts when placed only at a given projection distance, z, from scanned beam projector 100. For example, in one particular embodiment, the pitch of the periodic elements of the MLA of display screen 210 may be varied across the surface of display screen 210 so that the ratio of beamlet-spacing-at-the-eye-viewing-plane to the zero^{th}-order width is a constant for all or nearly all spot positions. For spot positions where the optical path from display screen 210 to the viewer's eye 218 is shorter, a smaller pitch from nominal may be utilized to enlarge angular separation between diffraction orders. Likewise, for spot position where the optical path from display screen 210 to the viewer's eye 218 is longer an increased pitch may be utilized in order to maintain uniformity due to beamlet coherent tiling artifacts. For further uniformity and control of Moiré, the raster ripple, or uniformity across a full-on raster at the screen, can be minimized.

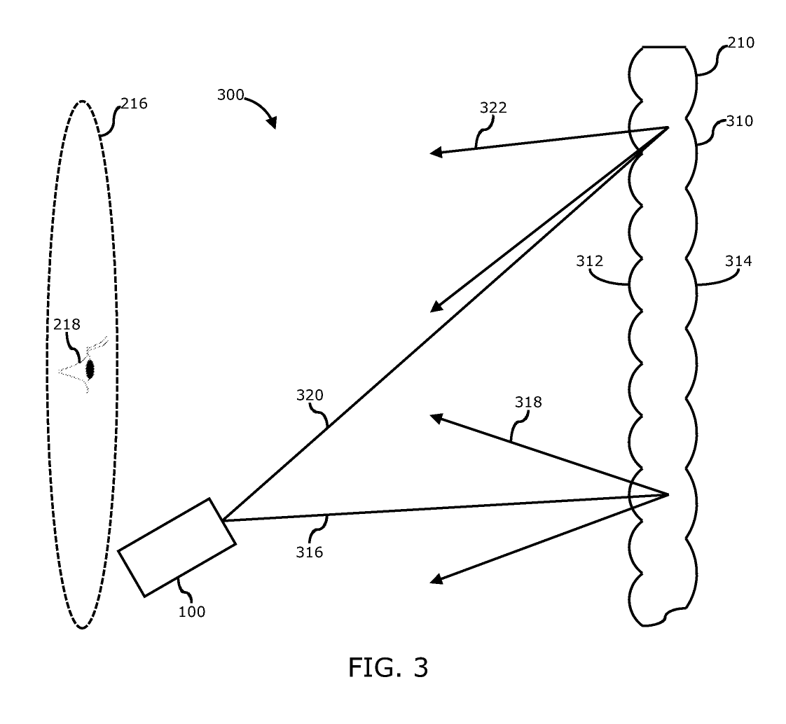

In one or more embodiments, coherent artifacts such as tiling and/or moiré in the displayed image may be reduced or eliminated, for example by designing projection display system 200 so that angular resolution is not above eye acuity, that is a maximum of about approximately 60 pixels per degree (ppd) as defined by the reciprocal of the angle subtended by one pixel from the eye plane. Furthermore, dynamic moiré artifact control may be utilized in order to enable higher uniformity in the display image, for example by providing a Gaussian profile to emitted beams 124, or alternatively by providing the emitted beams 124 to have a top hat or rounded-top-hat profile, however the scope of the claimed subject matter is not limited in this respect. In the embodiment shown in FIG. 2, the redirection of the reflected beams 214 within a relatively tighter eyebox 216 having a higher uniformity and higher efficiency due to creation of overlapping light exit cone bundles may be accomplished via the elliptical profile of display screen 210. In one or more alternative embodiments this may be achieved using a generally planar display screen 210, for example as shown in and described with respect to FIG. 3, below.

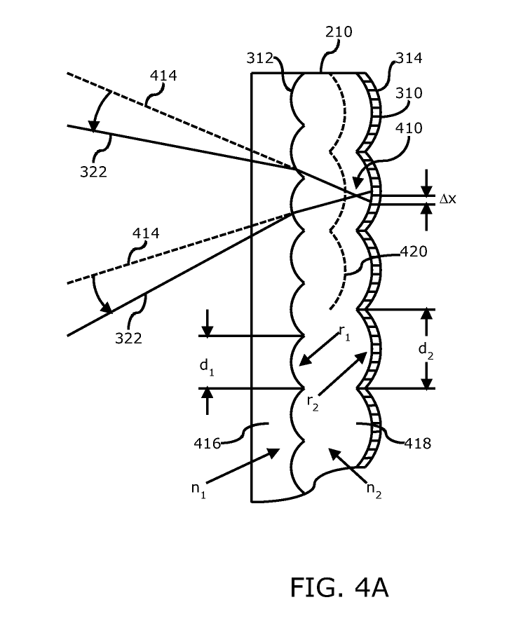

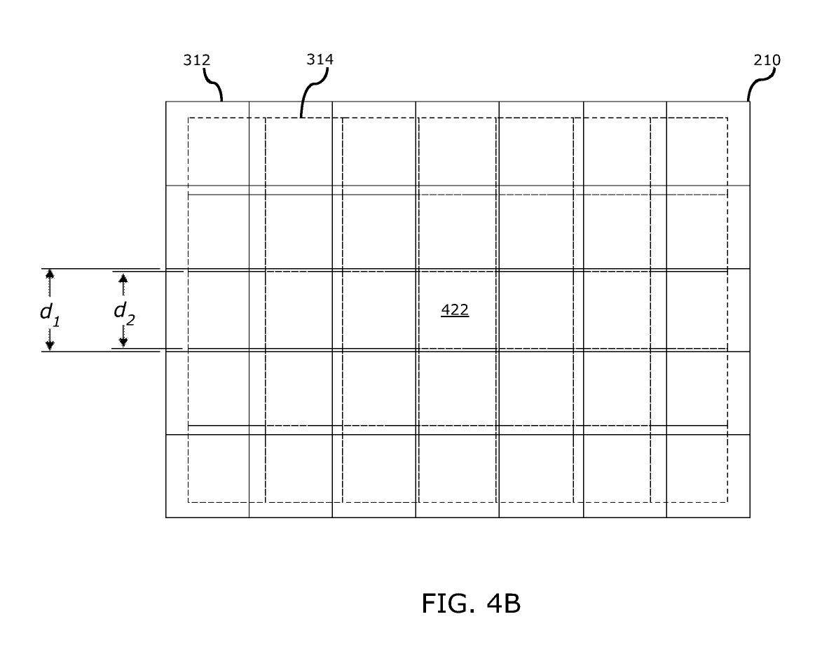

Referring now to FIG. 3, a diagram of a scanned beam display system including a pseudo-retroreflecting display screen to provide higher uniformity in accordance with one or more embodiments will be discussed. As shown in FIG. 3, projection display system 300 is substantially similar to projection display system 200 of FIG. 2 except that display screen 210 may be designed to have a generally planar profile as opposed to the elliptical profile of display screen 210 of FIG. 2. Furthermore, since the arrangement of the elements of display system 300 is not based on the geometry of an ellipse as shown in FIG. 2, there may be more freedom in the placement of display screen 210 with respect to scanned beam display 100 and the viewer's eye 218. This may be accomplished by providing display screen 210 with redirection properties accomplished via pseudo-retroreflection and/or numerical aperture (NA) expansion properties. Such a display screen 201 may be designed to have an at least partially reflective layer 310 and a dual MLA comprising a first MLA 312 and a second MLA. As will be discussed in further detail with respect to FIG. 4, first MLA 310 may have a first pitch and/or lens radius, and second MLA 312 may have a second pitch and/or lens radius which is different than the first pitch and/or lens radius of first MLA. In such an arrangement of display screen 210, emitted beams 316 from scanned beam display 100 that impinge on display screen 210 at normal or near normal angles to display screen 210 will be reflected toward eyebox 216 in exit NA cones or bundles 318 that are generally normal or nearly normal to the plane of display screen 210. Furthermore, emitted beams 320 from scanned beam display 100 that impinge on display screen 210 at larger angles will be reflected toward eyebox 216 in exit NA cones 322 that are generally not normal to the plane of display screen 210 but instead are directed toward eyebox 216 by an angular offset from a line normal to the plane of display screen 210. Thus, such an arrangement of display screen 210 may achieve the same or nearly the same redirecting properties of the elliptical display screen 210 of FIG. 2 using a planar display screen 210 to provide an image contained within a relatively smaller or tighter eyebox 216 at higher uniformity and/or gain. This redirecting property of display screen 210 of FIG. 3 allows exit NA cones or bundles in eyebox 216 to overlap at a location selected by the design of the pitches of first MLA 312 and second MLA 314 and/or the spacing between first MLA 312 and second MLA 314 as will be discussed in greater detail with respect to FIG. 4, below.

Referring now FIGS. 4A and 4B, diagrams of the pseudo-retroreflecting display screen of FIG. 3 illustrating the redirection of the exit numerical aperture exit cones in accordance with one or more embodiments will be discussed. As shown in FIG. 4A, display screen 210 may be designed to have a selected redirection property of redirecting exit NA cones reflected from display screen based on the X-Y position along display screen 210 combined with NA expansion. In one or more embodiments, such a display screen 210 may comprise a non-telecentric dual MLA having first MLA 312 and a second MLA 314 and further comprising a reflective, or at least partially reflective, coating 310 disposed on the farther MLA 314. Such an arrangement of display screen 210 results in at least partial retro-reflectivity of display screen 210. In one or more embodiments, first MLA 312 may comprise an array of lenslets or cells having a first pitch d₁ and/or a first radius r₁, and second MLA 314 may comprise an array of lenslets or cells having a second pitch d₂ and/or a second radius r₂. First MLA 312 may be disposed on a first material 416, or alternatively may comprise a second material 418, having a first index of refraction n₁, and second MLA 314 may be disposed on a material, or alternatively may comprise a material, having a second index of refraction n₂, for example to achieve desired reflection angles, which may be further adjusted via selection of appropriate radii r₁ and r₂, the thickness of material 416 and/or material 418, and/or the X-Y offset position achieved via the difference in pitches d₁ and d₂. In one or more embodiments, the thickness of material 418 may be selected to dispose second MLA 314 at a position beyond the focal length 410 of first MLA 312 as shown in FIG. 4. Alternatively, second MLA 314 could be disposed at a position within the focal length 410 of first MLA 312, as shown by dotted line 420, and the scope of the claimed subject matter is not limited in this respect. Furthermore, first MLA 312 may comprise a transmissive and/or ambient rejection (AR) coated MLA, and second MLA 314 may comprise a reflective or at least partially reflective MLA via coating 310. In one or more embodiments, coating 310 may comprise a black matrix surround and/or black absorber, and may utilize self-alignment of mirror regions via exposure, although the scope of the claimed subject matter is not limited in this respect. As a result of one or more of the above listed parameters, display screen 210 may be designed to provide an angular offset in redirecting the exit NA cones 322 from a normal directly exit cone 414 as a function of X-Y position on display screen 210. This angular offset in the direction of exit NA cones 322 may result from the linear offset Δx between lenslet centers at a particular location on the screen thereby forming bundle overlap and bundle angle bias due to the difference in pitch d₁ and d₂ of first MLA 312 and second MLA 314 to provide a desired amount of redirecting. It should be noted that the particular arrangement of display screen 210 of FIG. 4A is one example of a generally planar display screen capable of redirecting exit NA cones toward a generally smaller eyebox 216, however other arrangement of display screen 216 may likewise achieve exit NA cone redirecting, and the scope of the claimed subject matter is not limited in this respect.

FIG. 4B shows a front elevation view of display screen 210 comprising first MLA 312 disposed in front of second MLA 314 wherein second MLA is pseudo-retro-reflecting via coating 310 as shown in FIG. 4A. In one or more embodiments, first MLA 312 has a first pitch d₁ and second MLA 314 has a second pitch d₂ that is different than the first pitch d₁. Pitch d₁ may be greater than second pitch d₂, or alternatively pitch d₁ may be less than second pitch d₂, and the scope of the claimed subject matter is not limited in this respect. In one or 210 may be generally aligned or coincident with lenslets of second MLA 314 at the center 422 of display screen 210. Since the pitches of the MLAs are different, the lenslets of the two MLAs become less aligned or coincident at farther distances away from center 422 of display screen in both the horizontal (X) and vertical (Y) directions. Thus, the amount of angular redirection of exit cones may be a function of X-Y position on display screen 210 in one or more embodiments, although the scope of the claimed subject matter is not limited in this respect. Furthermore, although FIGS. 4A and 4B show a rectilinear arrangement of lenslets, and wherein the lenslets may generally be rectilinear in shape, other arrangements of display screen 210 may be provided such as, for example, square, rectangular, elliptical, circular, hexagonal, rhomboidal, and so on, and the scope of the claimed subject matter is not limited in these respects.

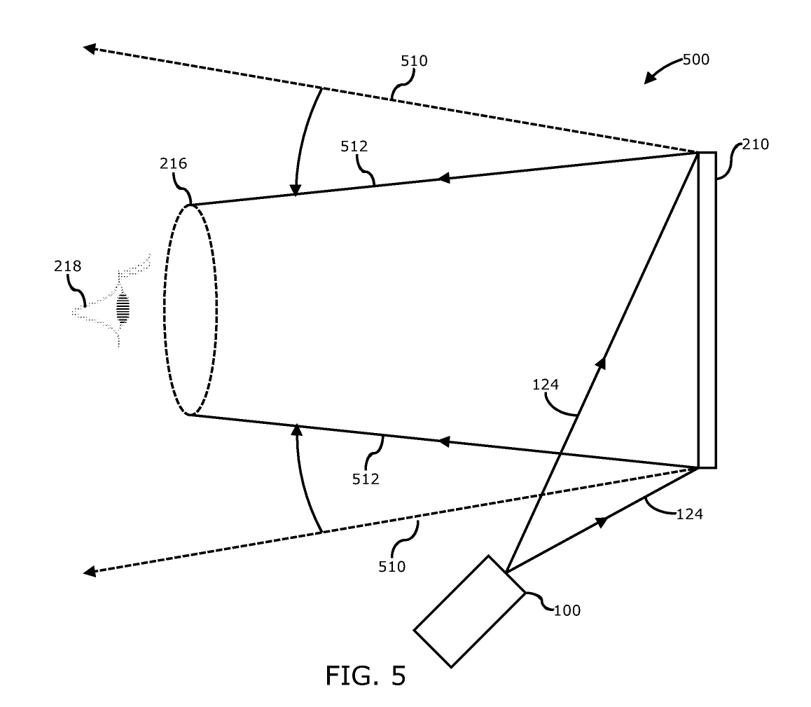

Referring now to FIG. 5, a diagram of a scanned beam display system having a planar display screen illustrating the redirection of the exit numerical aperture exit cones in accordance with one or more embodiments will be discussed. As shown in FIG. 5, display screen 210 may comprise a generally planar form factor overall that is capable of redirecting emitted beams 124 into exit NA cones 512 into a relatively smaller sized eyebox 216 to provide a displayed image having higher brightness due to increased efficiency of directing usable light into the eyebox, higher uniformity and/or gain when viewed by the viewer's eye 218. Display screen 210 has the ability to control not only exit NA cone size but also the redirecting properties that redirect the exit NA cones to overlap. Thus, by limiting exit cone angular extent, what would otherwise comprise a wider angle display cone 510 can be made into a relatively smaller angle display cone 512, increasing screen gain, thus increasing display efficiency into the desired viewing eyebox, thus increasing display luminance. By further redirecting the exit NA cones to overlap at the viewing plane, uniformity across the Field of View (FOV) is increased. Such arrangements of a display system 500 may be utilized for example in head-up display systems, or in applications where a limited viewing angle of a displayed image may be desired such as to protect the privacy and/or secrecy of the displayed image. However, these are merely examples of applications of display system 500 including a display screen 210 having exit NA cone redirecting properties, and the scope of the claimed subject matter is not limited in these respects.

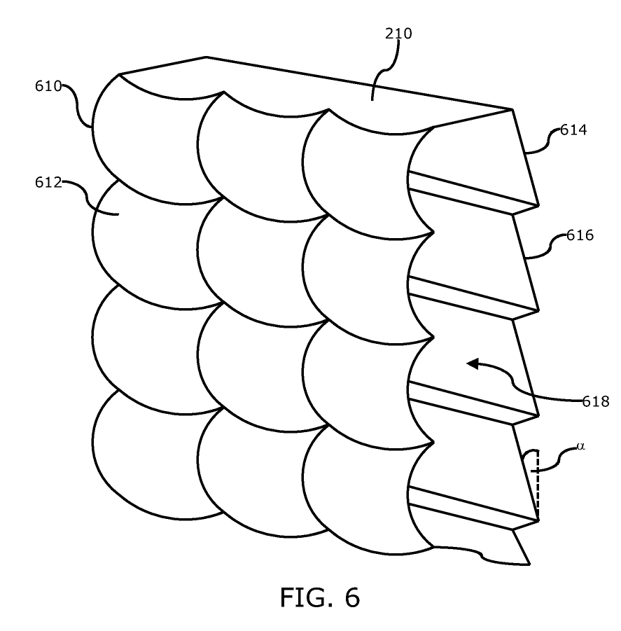

Referring now to FIG. 6, a diagram of the planar display screen of FIG. 5 having a prismatic array to provide redirection of the exit numerical aperture exit cones in accordance with one or more embodiments will be discussed. As shown in FIG. 6, display screen 210 may comprise a diffuser layer 610 comprising one or more diffuser elements 612, and a prismatic array 614 comprising an array of one or more prismatic, or faceted, elements 616. In one or more embodiments, diffuser layer may be transmissive or at least partially transmissive, and prismatic layer 614 may be reflective or at least partially reflective. Alternatively, diffuser layer 610 may comprise an MLA having an array of lenslets 612 as array elements. Further alternatively, prismatic layer 614 may comprise a reflective Fresnel. Prismatic layer 614 may operate in conjunction with diffuser layer 610 to redirect the exit cones into a desired viewing region or eyebox 216, thereby allowing higher efficiency and/or gain of the displayed image. Thus, by using a random surface relief diffuser layer 610 along with a reflective prismatic array 614, or Fresnel, display screen 210 may reflect incoming beams emitted by a scanned beam display 100 into an exit cone to provide an image having higher uniformity across the Field of View (FOV) and/or smoother roll-off uniformity across the eyebox 216. For the case of using an MLA as diffuser layer 610, the uniformity across the eyebox can be designed to further provide nearly constant intensity, or flat-top intensity distribution, across the defined eyebox in addition to forming an overlapping eyebox from all field points, or exit pupil, which achieves uniformity across the FOV. Such an arrangement of display screen 210 results in redirection properties to redirect the exit cones from all or nearly all field of view (FOV) points toward the viewing region or eyebox 216. Exit cone angles scattered by diffuser layer 610 and resulting from on-axis or off-axis projection onto display screen 210 can be redirected toward eyebox 216 via prismatic array 614. In one or more alternative embodiments, prismatic array 614 may comprise a reflective cylindrical Fresnel, reflective circularly symmetric Fresnel, reflective anomorphic or aspheric Fresnel, and/or reflective grid-faceted Fresnel array, although the scope of the claimed subject matter is not limited in these respects. Since diffuser layer 610 may be random, some speckle effects may be visible. The speckle density and effective spot size emanating from display screen 210 may be traded off via selection of the diffusion angle or reflection angle α and/or the thickness of the gap or material 618 disposed between diffuser layer 610 and prismatic array 614 to minimize or reduce speckle appearance by increasing speckle density at the viewing plane, although the scope of the claimed subject matter is not limited in these respects. In one or more embodiments, the angle α may range from about 13 degrees to about 22 degrees, although the scope of the claimed subject matter is not limited in this respect.

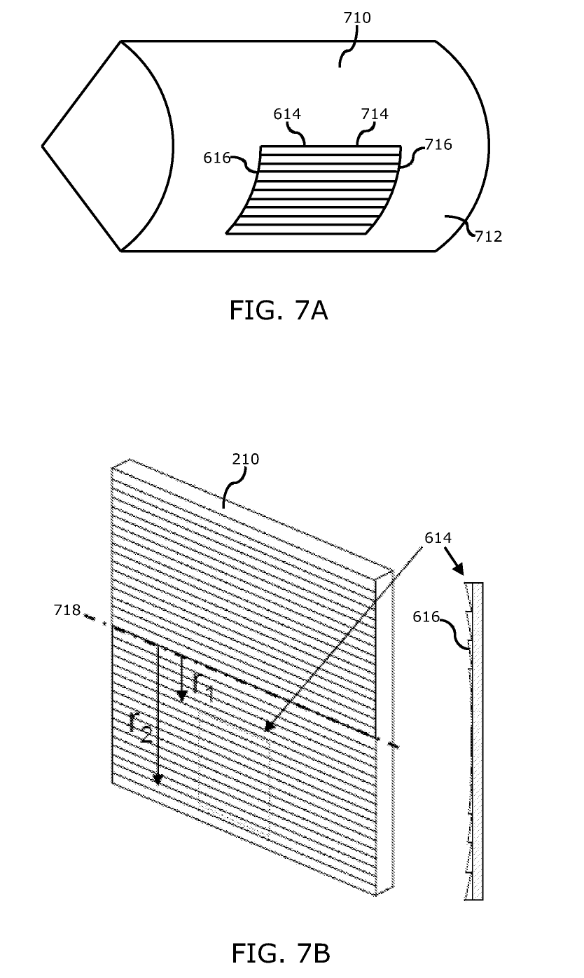

Referring now to FIGS. 7A and 7B, diagrams illustrating a cylindrical profile of a Fresnel reflector of a planar display screen to provide redirection of the exit numerical aperture exit cones in accordance with one or more embodiments will be discussed. In one or more embodiments, prismatic reflector 614 may comprise a cylindrical Fresnel reflector 614 formed from a surface section 712 of a cylinder 710 such that the reflector elements 616 generally have a topology of a cylinder 710. As a result, the Fresnel type reflector 614 may have a generally linear topology in a first direction 714, such as the X or horizontal direction, and may have a generally curved topology in a second direction 716, such as the Y or vertical direction wherein portions of reflector 614 that are in the middle region along the vertical are closer to the viewer's eye 218 than portions of reflector 614 that are near the top or bottom regions along the vertical. Such an arrangement may provide overlap of the exit cones at the eye plane in eyebox 216 along the vertical direction. Overlap of the exit cones at the eye plane may be achieved via cylindrically shaped elements or lenses 612 in diffuser or MLA layer 610. However, having prismatic or Fresnel reflector 614 following a cylindrical topology as shown in FIG. 7A provides for overlap of the exit cones in the form of a one-dimensional angular correction only along the vertical direction, or direction which contains the power of the element, and is merely one topology for reflector 614, and the scope of the claimed subject matter is not limited in this respect.

FIG. 7B shows how a cylindrical Fresnel reflector 614 as shown in FIG. 7A may be planarized by moving the Fresnel elements 616 to be generally lie in a plane as shown in FIG. 7B. In the embodiment shown in FIG. 7B, the Fresnel reflector 614 may comprise a concave cylindrical Fresnel having off-axis Fresnel elements 616, or facets, wherein the Fresnel elements 616 have a nominal facet angle of α=13.5° and in general an element pitch, d, of about 150 μm≦d≦300 μm. In the case of using a front-side reflective-coated concave Fresnel, the diffuser layer, whether MLA or random surface relief, can be laminated or replicated directly over the front reflective surface of the Fresnel. The angle, α, is dependent on the projection input angle as well as the orientation of the screen surface normal with respect to the desired viewing eyebox location. In one particular embodiment, Fresnel element 614 may be generally rectilinear and be about 155 mm or greater in a horizontal direction and about 100 mm or more in a vertical direction. The top Fresnel elements 616 may be disposed at a first distance r₁ off axis 718 and the bottom Fresnel elements 616 may be disposed at a second distance r₂ off axis 718. In one or more embodiments, Fresnel reflector 614 may comprise a back-side reflective-coated convex cylindrical Fresnel if the thickness is relatively thin and controlled wherein the elements 616 are sized to be about 250 μm to about 300 μm. In the case of using a convex reflective-coated Fresnel, the coated Fresnel side faces away from the projected input, so that the projected light encounters the diffusing layer first, whether MLA or random surface relief, and then reflected off the Fresnel, which serves as a concave Fresnel as seen from within the screen Fresnel media. In one or more particular embodiments, the elements 616 may be anomorphic to further facilitate overlap of the exit cones from display 210. Following along the vertical direction, suitable facet angles of elements 616 may range from about α=10.3°±1° at or near the top of Fresnel reflector 614 (i.e., near r₁), α=13.5°±1° at or near the center of Fresnel reflector 614, and α=16.3°±1° at or near the bottom of Fresnel reflector 614 (i.e., near r₂). In one or more embodiments, Fresnel reflector 614 may comprise an acrylic material or the like having an effective focal length (EFL) of about 1270 mm and where r₁=80 mm, and r₂=r₁+100 mm, or about 180 mm, such that an overlapping eyebox is formed at about 775 mm from the screen. However, these are merely example values for Fresnel reflector 614 and the scope of the claimed subject matter is not limited in these respects.

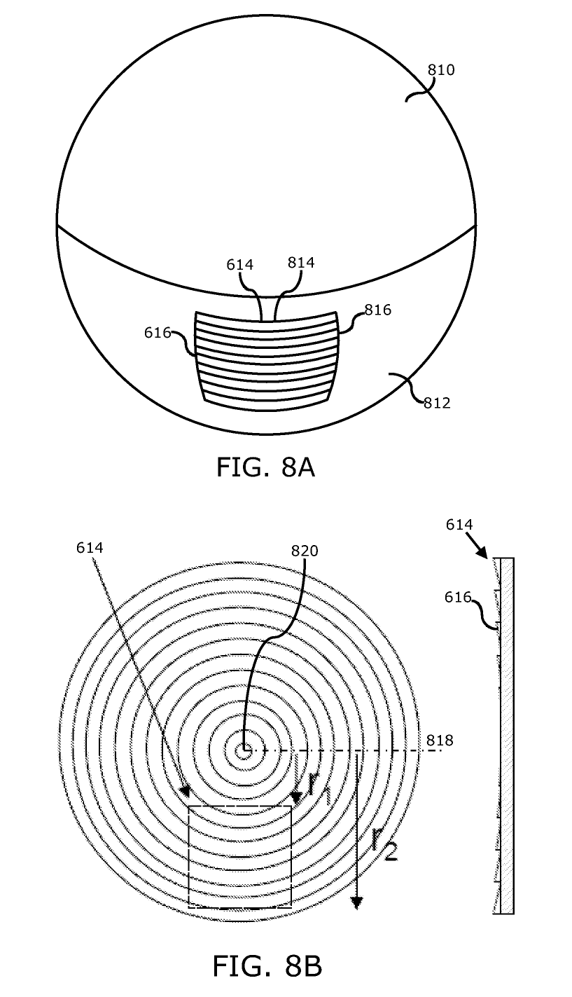

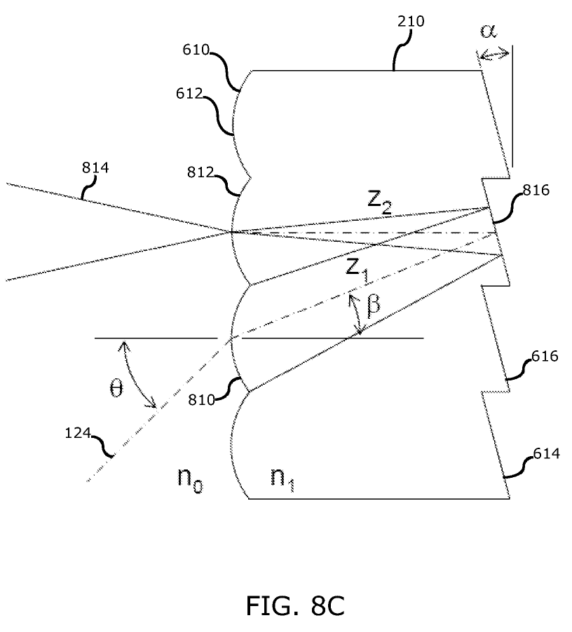

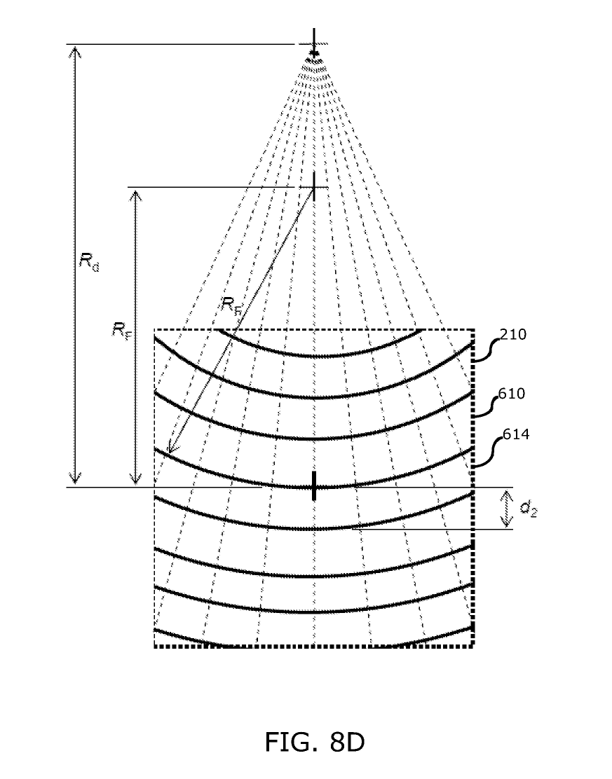

Referring now to FIGS. 8A, 8B, 8C, and 8D, diagrams illustrating a spherical profile of a Fresnel reflector of a planar display screen to provide redirection of the exit numerical aperture exit cones in accordance with one or more embodiments will be discussed. The topology of reflector 614 as shown in FIG. 8 is substantially similar to the topology of reflector 614 as shown in FIG. 7 but using a spherical topology instead of a cylindrical topology. Thus as shown in FIG. 8, reflector 614 may generally follow the topology of a section 812 of a sphere 810 wherein reflector 614 has a curvature along a horizontal axis 814 in the X direction, and has a curvature along a vertical axis 816 in the Y direction. Such a spherical topology of reflector 614 provides overlap of the exit cones in both the vertical and the horizontal direction, in the form of a two-dimensional angular correction, without the need for a cylindrical lens or element 612 in diffuser or MLA layer 610.

FIG. 8B shows how a spherical Fresnel reflector 614 as shown in FIG. 8A may be planarized by moving the Fresnel elements 616 to generally lie in a plane as shown in FIG. 8B. In the embodiment shown in FIG. 8B, the Fresnel reflector 614 may comprise a concave spherical Fresnel having off-axis Fresnel elements 616, or facets, wherein the Fresnel elements 616 have a nominal facet angle of α=13.5° and in general an element pitch, d, of about 150 μm≦d≦300 μm. In the case of using a front-side reflective-coated concave Fresnel, the diffuser layer, whether MLA or random surface relief, can be laminated or replicated directly over the front reflective surface of the Fresnel. The angle α is dependant on the projection input angle as well as the orientation of the screen surface normal with respect to the desired viewing eyebox location. In one particular embodiment, Fresnel element 614 may be generally rectilinear and be about 155 mm or greater in a horizontal direction and about 100 mm or more in a vertical direction. The top Fresnel elements 616 may be disposed at a first distance r₁ off axis 818 and the bottom Fresnel elements 616 may be disposed at a second distance r₂ off axis 818 passing through center 820. In one or more embodiments, Fresnel reflector 614 may comprise a back-side reflective-coated convex spherical Fresnel if the thickness is relatively thin and controlled wherein the elements 616 are sized to be about 250 μm to about 300 μm. In the case of using a convex reflective-coated Fresnel, the coated Fresnel side faces away from the projected input, so that the projected light encounters the diffusing layer first, whether MLA or random surface relief, and then reflected off the Fresnel, which serves as a concave Fresnel as seen from within the screen Fresnel media. In one or more particular embodiments, the elements 616 may be anomorphic to further facilitate overlap of the exit cones from display 210. Following along the vertical direction, suitable facet angles of elements 616 may range from about α=10.3°±1° at or near the top of Fresnel reflector 614 (i.e., near r₁), α=13.5°±1° at or near the center of Fresnel reflector 614, and α=16.3°±1° at or near the bottom of Fresnel reflector 614 (i.e., near r₂). In one or more embodiments, Fresnel reflector 614 may comprise an acrylic material or the like having an effective focal length (EFL) of about 1270 mm and where r₁=80 mm, and r₂=r₁+100 mm, or about 180 mm, such that an overlapping eyebox is formed at or near 775 mm from the screen. However, these are merely example values for Fresnel reflector 614 and the scope of the claimed subject matter is not limited in these respects.

FIG. 8C shows how an exit cone 814 may hop to a lenslet 812 of MLA 612 that is different from the lenslet 810 on which a scan beam 124 is incident on MLA 610 for an arced Fresnel reflector 614 such as spherical Fresnel reflector 614 shown in FIG. 8A and/or FIG. 8B. As shown in FIG. 8C, an incoming scan beam 124 may be incident on lenslet 810 at an angle, θ, with respect to a line normal to display screen 210. Lenslet 810 may redirect beam 124 at an angle, β, with respect to normal, toward Fresnel element 816 as Fresnel element (facet) 816 along optical path Z₁. The internal beam is then reflected off Fresnel element 816 toward lenslet 812 along optical path Z₂ to exit display screen 210 from the location of lenslet 812 as exit cone 814. It should be noted that two modes of operation are possible: the case where the input scan angles are within the exit cone extent of the display, and the case where the input scan angles are outside the exit cone extent of the display. For the case of the input scan angles within the exit cone extent, the light passing through a particular lenslet of the first MLA will exit through the same lenslet after being reflected by a corresponding lenslet of the reflective second MLA. However, for the case of input scan angles outside the exit cone extent, as shown in FIG. 8C, the light passing through a particular lenslet of the first MLA can be designed to exit through a neighboring lenslet of the first MLA after being reflected by a corresponding lenslet of the reflective second MLA. The former case can be used for screens where a projector is at, in front of, or within limited proximity of the viewer thus forming a pseudo-retroreflecting yet expanding screen, while the latter can be used in applications where the projector is placed substantially off-axis with respect to the screen thus enabling the light to be hopped to a neighboring output exit cone to form the eyebox at an angle substantially normal to the screen surface. In one or more embodiments, the MLA-on-reflective-Fresnel type display screen 210 may be formed with the following parameters for a hopped exit cone case with projector off-axis near 45 deg tilt: MLA Fresnel-matching pitch of d₁=267.9 μm, horizontal MLA pitch varies dx=223 μm near top center, dx=267.9 μm near middle center and dx=331.8 μm near bottom center, Fresnel pitch d₂=267.9 μm, separation distance D=450 μm, o_{y}=0 μm, lenslet profile radius R₁=571 μm, although the scope of the claimed subject matter is not limited in these respects.

FIG. 8D shows layout parameters for a display screen 210 having an MLA 610 and an arced Fresnel reflector 614 such as the spherical Fresnel reflector 614 shown in FIGS. 8A and/or 8B. In one or more embodiments, varying the length of R_{d} may be utilized to determine variation of horizontal pitch from top to bottom of display screen 210. In one or more embodiments, R_{d} can be negative to allow a larger pitch at the top of display screen 210 than at the bottom of display screen in contrast to what is shown in FIG. 8D. In one or more embodiments, R_{f} can be defined as the distance from the center of Fresnel reflector to the center of the screen design layout, while R_{d} can represent the distance from the screen layout center to a point at which equally angularly spaced lines are drawn radially over the screen area. The crossover points of these radial lines and the centers of all facets can be used to locate the lenslet centers. After defining a nominal pitch at the center, the relative magnitude of R_{d} to R_{F} can be used to control the variation in pitch along, say, the horizontal. Relatively large negative values for R_{d} can be used to achieve a horizontal pitch that is larger at top instead of at bottom, as in the case of relatively large positive R_{d}. Since coherent tiling artifacts can be minimized or reduced by selecting the pitch of the MLA of display screen 210 at each position across display screen 210 so as to maintain a ratio of beam size to diffraction order spacing at the viewing plane, it should be noted that variation of non-diffused beam size, as shown in and described with respect to FIG. 12, below, at the eye viewing plane due to geometry of the scanned display input beam can be accounted for by variation of the Fresnel pitch d₂ across the screen, as well as an appropriate correlating MLA pitch across the screen. In one or more embodiments, this variation may be made along the vertical, although the scope of the claimed subject matter is not limited in this respect.

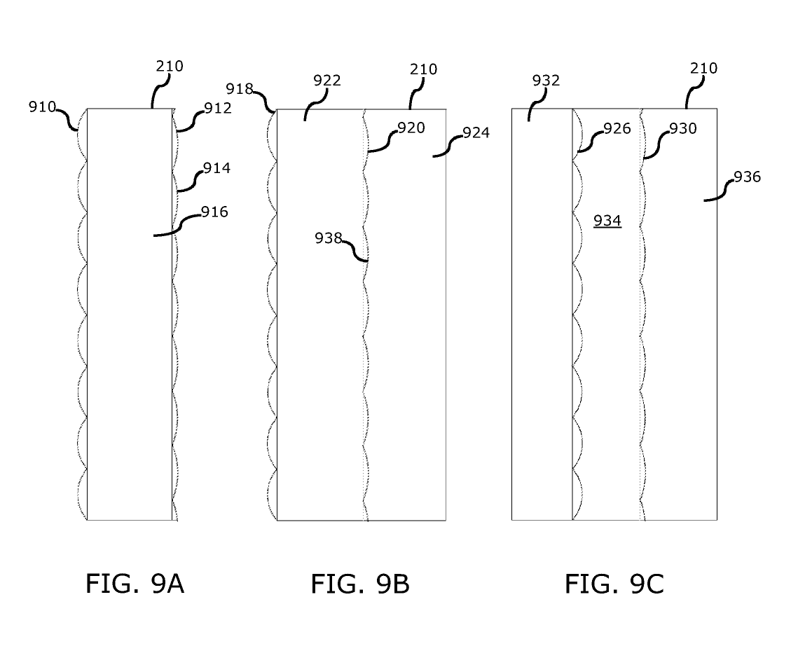

Referring now to FIGS. 9A-9C, diagrams of a generally planar display screen for a scanned beam display system comprising a double sided microlens array (MLA) to provide redirection of the exit numerical aperture exit cones in accordance with one or more embodiments will be discussed. As shown in FIGS. 9A, 9B, and 9C, display screen 210 may be utilized to achieve normal or near-normal exit cones from emitted beams 124 from scanned beam display 100 that impinge on display screen 210 off-axis, for example from about 23° to about 45° in one or more embodiments. FIG. 9A shows one embodiment of display screen 210 comprising a double-sided MLA comprising a first MLA 910 and a second MLA 912 formed on an optical medium 916 where one of the MLAs may be coated with a reflector 914, for example as a back reflective coating on second MLA 912. In another embodiment shown in FIG. 9B, display screen 210 comprises a first MLA 918 formed in a first optical medium 922 that is in turn laminated to a second optical medium 924 having a second MLA 920 formed thereon where the second MLA 920 may have an optical coating 938 disposed thereon. In yet another embodiment shown in FIG. 9C, display screen 210 may comprise a first optical medium 932 having a first MLA 926 disposed thereon and a second optical medium 936 having a second MLA 930 disposed thereon, and further comprising an air gap 934 disposed between the first optical medium 932 and the second optical medium 936. The second MLA 930 may have a reflective coating disposed thereon to reflect incoming beams back toward the eyebox 216. The parameters that can be used in design of such a screen include first MLA pitch d₁, second MLA pitch d₂, first MLA profile radius R₁, second MLA profile radius R₂, MLA to MLA separation distance D, refractive index, n, of the media between MLAs, and lateral offset oₓ and o_{y}.

It should be noted that two modes of operation are possible: the case where the input scan angles are within the exit cone extent of the display, and the case where the input scan angles are outside the exit cone extent of the display. For the case of the input scan angles within the exit cone extent, the light passing through a particular lenslet of the first MLA will exit through the same lenslet after being reflected by a corresponding lenslet of the reflective second MLA. However, for the case of input scan angles outside the exit cone extent, the light passing through a particular lenslet of the first MLA can be designed to exit through a neighboring lenslet of the first MLA after being reflected by a corresponding lenslet of the reflective second MLA. The former case can be used for screens where a projector is at, in front of, or within limited proximity of the viewer thus forming a pseudo-retroreflecting yet expanding screen, while the latter can be used in applications where the projector is placed substantially off-axis with respect to the screen thus enabling the light to be hopped to a neighboring output exit cone to form the eyebox at an angle substantially normal to the screen surface. In one or more embodiments, the two-layer or double-sided MLA having one side reflective-coated type display screen 210 may be formed with the following parameters for a hopped exit cone case with projector off-axis near 45 deg tilt: d₁=140 μm, d₂=140.033 μm, at bottom D=350 μm and near top D=300 μm, at bottom o_{y}=96 μm and near top o_{y}=120 μm, R₁=100 μm and R₂=190 μm, although the scope of the claimed subject matter is not limited in these respects. Such arrangements of display screen 210 as shown in FIGS. 9A, 9B, and/or 9C may allow overlap of exit cones at the eyebox 216 without requiring curvature of display screen 210 away from a planar form factor. It should be noted that the since display screen 210 comprises two MLAs as shown, display screen 210 is at least pseudo-exit-pupil forming and may provide numerical aperture expansion, although the scope of the claimed subject matter is not limited in these respects.

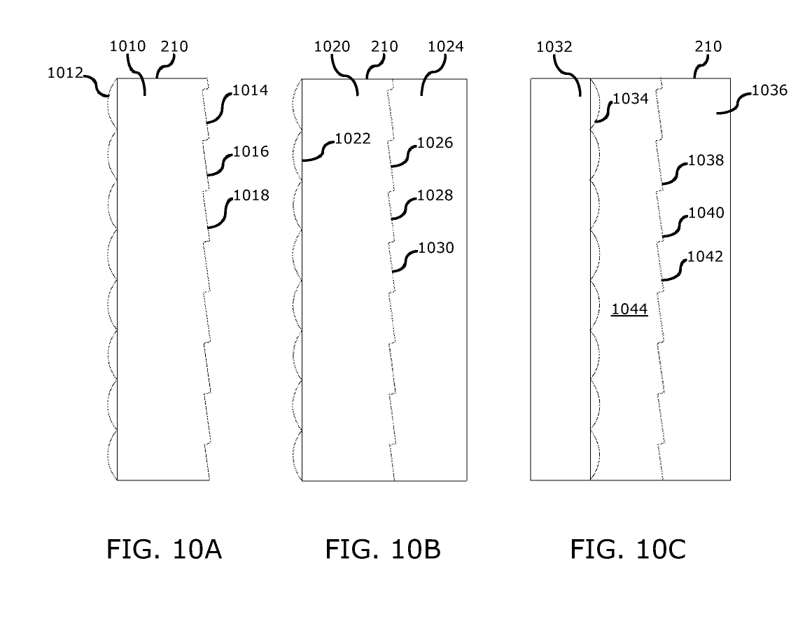

Referring now to FIGS. 10A-10C, diagrams of a generally planar display screen for a scanned beam display system comprising a microlens array and a prismatic or Fresnel reflector to provide redirection of the exit numerical aperture exit cones in accordance with one or more embodiments will be discussed. In the embodiment shown in FIG. 10A, display screen 210 may comprise a double sided optical medium 1010 having an MLA 1012 formed on one side of the optical medium 1010, and a prismatic array 1014 of one or more prismatic elements 1016 having a reflective coating 1018 disposed on a back surface of prismatic array 1014. Alternatively, prismatic array 1014 may comprise a blazed grating or a Fresnel reflector such as a cylindrical Fresnel reflector, a spherical Fresnel reflector, an anomorphic or aspheric Fresnel reflector, or a grid-faceted Fresnel reflector, although the scope of the claimed subject matter is not limited in these respects. In the embodiment shown in FIG. 10B, display screen 210 may comprise a first optical medium 1020 having an MLA 1022 formed thereon, and a second optical medium 1024 having prismatic array 1026 of one or more prismatic elements 1028 formed thereon wherein the prismatic array 1026 has a reflective coating 1030 disposed thereon. The first optical medium 1020 may be laminated to the second optical medium 1024 to form display screen 210. Alternatively, prismatic array 1926 may comprise a blazed grating or a Fresnel reflector such as a cylindrical Fresnel reflector, a spherical Fresnel reflector, an anomorphic or aspheric Fresnel reflector, or a grid-faceted Fresnel reflector, although the scope of the claimed subject matter is not limited in this respect. In the embodiment shown in FIG. 10C, display screen 210 may comprise a first optical medium 1032 having an MLA 1034 formed thereon, and a second optical medium 1026 having a prismatic array 1038 of one or more prismatic elements 1040 disposed thereon wherein the prismatic array 1038 has a reflective coating 1042 disposed thereon, and further comprising an air gap 1044 disposed between first optical medium 1032 and second optical medium 1044. Alternatively, prismatic array 1038 may comprise a blazed grating or a Fresnel reflector such as a cylindrical Fresnel reflector, a spherical Fresnel reflector, an anomorphic or aspheric Fresnel reflector, or a grid-faceted Fresnel reflector, although the scope of the claimed subject matter is not limited in these respects.

In the embodiments shown in FIG. 10A, FIG. 10B, and/or FIG. 10C, the elements 1016, 1028, and/or 1040 may have a tilt with respect to vertical, that is away from the plane of display screen 210, at a non-zero angle, for example which may comprise an angle of about 10 degrees to about 20 degrees in one or more embodiments, and in general the facet angles of the elements may be the same across display screen 210, although the scope of the claimed subject matter is not limited in this respect. The scan angle of the incoming beams 124 from scanned beam display 100 may range from about 34 degrees to about 56 degrees in one or more embodiments, and may result in the output exit cones being beam steered toward eyebox 216. The parameters that can be used in design of such a screen include MLA pitch d₁, Fresnel facet pitch d₂, MLA profile radius R, MLA to Fresnel plane separation distance D, refractive index of the media between MLA and Fresnel n, and lateral offset o, or additionally oₓ and o_{y}. It should be noted that two modes of operation are possible: the case where the input scan angles are within the exit cone extent of the display, and the case where the input scan angles are outside the exit cone extent of the display. For the case of the input scan angles within the exit cone extent, the light passing through a particular lenslet of the MLA will exit through the same lenslet after being reflected by a corresponding facet of the reflective Fresnel or reflective prismatic array, and lower facet tilt angles are needed. However, for the case of input scan angles outside the exit cone extent, the light passing through a particular lenslet of the MLA can be designed to exit through a neighboring lenslet of the MLA upon exit after being reflected by a corresponding facet of the reflective Fresnel or reflective prismatic array, and higher facet tilt angles are needed in this case. The former case can be used for screens where a projector is at, in front of, or within limited proximity of the viewer thus forming a pseudo-retroreflecting yet expanding screen, while the latter can be used in applications where the projector is placed substantially off-axis with respect to the screen thus enabling the light to be hopped to a neighboring output exit cone to form the eyebox at an angle substantially normal to the screen surface. In one or more embodiments, display screen may have the following parameters for a hopped exit cone case with projector off-axis near θ=45° tilt: d=156 μm, R=312 μm, α=16°, where the input scan angle from screen surface normal is larger such as about 56°, α=about 10.8° wherein the input scan angle is smaller such as about 34°, D=290 μm, and o=134 μm, although the scope of the claimed subject matter is not limited in these respects.

For the case regarding a hopped exit cone in one or more embodiments, for example as shown in FIG. 8C above, the relationship of facet angle α to input angle θ is given in Eq. 1:

$$β = arcsin ( \frac{{n}_{0} sin ( θ )}{{n}_{1}} ) = 2 α \qquad Eq . 1$$

For improved uniformity, the total optical path, including distance from MLA to facet z₁, and distance from facet to exit lenslet z₂, should be approximately equal to the effective MLA lenslet focal length f_{eff}, and can be determined by Eq. 2:

$${f}_{eff} = {z}_{1} + {z}_{2} = \sqrt{{d}^{2} + {( \frac{d}{tan ( β )} )}^{2}} + \frac{d}{tan ( β )} \qquad Eq . 2$$

Further, for MLA design and fabrication purposes, note that the in-media MLA focal length at normal incidence fₘₗₐ is related to the effective focal length at angle of incidence θ approximately by Eq. 3:

$${f}_{mla} = \frac{{f}_{eff}}{cos ( θ )} \qquad Eq . 3$$

Note that the normal incidence focal length is longer than the effective focal length at off-axis angle of incidence. In addition, the MLA layout should conform to the Fresnel facet layout for better or optimal performance, as shown in and described with respect to FIG. 8D. In one or more embodiments, R_{f} can be defined as the distance from the center of Fresnel reflector to the center of the screen design layout, while R_{d} can represent the distance from the screen layout center to a point at which equally angularly spaced lines are drawn radially over the screen area. The crossover points of these radial lines and the centers of all facets can be used to locate the lenslet centers. After defining a nominal pitch at the center, the relative magnitude of R_{d} to R_{F} can be used to control the variation in pitch along, say, the horizontal. Relatively large negative values for R_{d} can be used to achieve a horizontal pitch that is larger at top instead of at bottom, as in the case of relatively large positive R_{d}. Since coherent tiling artifacts can be minimized or reduced by selecting the pitch of the MLA of display screen 210 at each position across display screen 210 so as to maintain a ratio of beam size to diffraction order spacing at the viewing plane, it should be noted that variation of non-diffused beam size, as shown in and described with respect to FIG. 12, below, at the eye viewing plane due to geometry of the scanned display input beam can be accounted for by variation of the Fresnel pitch d₂ across the screen. In one or more embodiments, this variation may be made along the vertical, although the scope of the claimed subject matter is not limited in this respect.

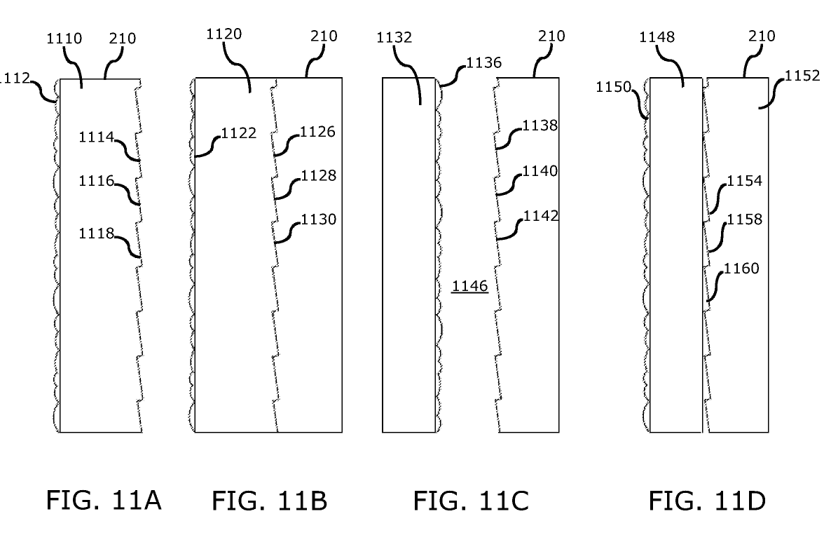

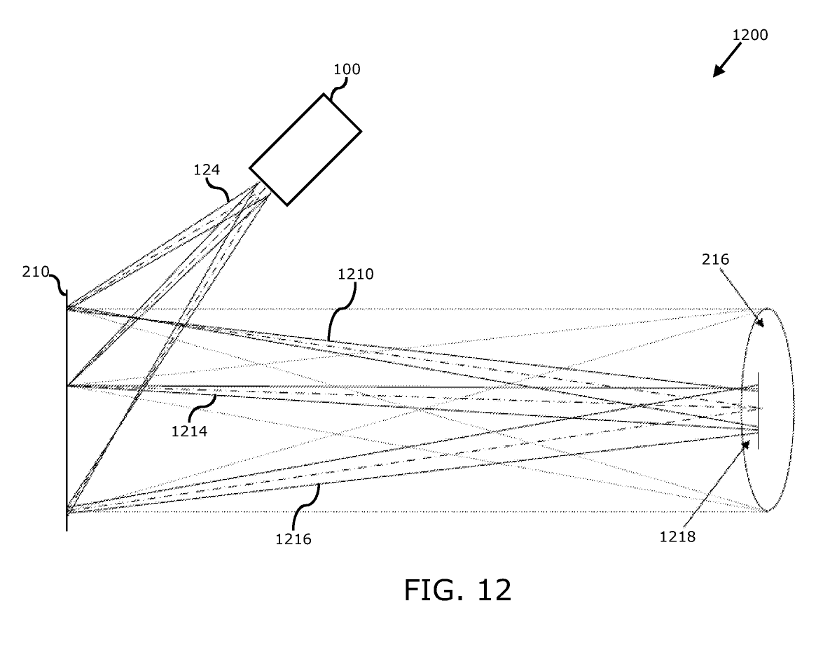

Referring now to FIGS. 11A-11D, diagrams of a generally planar display screen for a scanned beam display system comprising a diffuser and a prismatic reflector in accordance with one or more embodiments will be discussed. In one or more embodiments, display screen 210 comprises a double sided, back reflected coated display screen 210 in FIG. 11A wherein an optical material 1110 comprises a random dimpled diffuser 1112 on a first surface and a prismatic array 1114 of one or more elements 1116 and having a reflective coating disposed thereon. In the embodiment shown in FIG. 11B, display screen 210 comprises a first optical material 1120 having a random dimpled diffuser 1122 disposed thereon, and a second optical material 1124 having a prismatic array 1126 of one or more elements 1128 and having a reflective coating 1130 disposed thereon. The first optical material 1120 may be laminated to the second optical material 1124 to form display screen 210. In another embodiment shown in FIG. 11C, display screen 210 may comprise a first optical material 1132 having a random dimpled diffuser 1136 disposed thereon, and a second optical material 1144 having a prismatic array 1138 of one or more elements 1140 and having a reflective coating 1142 disposed thereon, and further comprising an air gap 1146 disposed between first optical material 1132 and second optical material 1144. In yet another embodiment shown in FIG. 11D, display screen 210 may comprise a first optical material 1148 having a random dimpled diffuser 1150 disposed thereon, and a second optical material 1152 having a prismatic array 1154 of one or more elements 1156 having a reflective coating 1158 disposed thereon. An air gap 1160 may be formed between the front surface of prismatic array 1160 and the back surface of the first optical material 1148 as shown. In one or more of the embodiments shown in FIGS. 11A, FIG. 11B, 11C, and/of FIG. 11D, one or more of prismatic array 1114, prismatic array 1126, prismatic array 1138, and/or prismatic array 1154 may alternatively comprise a blazed grating or a Fresnel reflector such as a cylindrical Fresnel reflector, a spherical Fresnel reflector, an anomorphic or aspheric Fresnel reflector, or a grid-faceted Fresnel reflector, although the scope of the claimed subject matter is not limited in these respects. In the embodiment of display screen 210 shown in FIG. 11A through FIG. 11D, scatter cone angles from on-axis or off-axis projection of emitted beams 124 from scanned beam display 100 may be redirected toward eyebox 216 for higher efficiency and/or gain, however the scope of the claimed subject matter is not limited in this respect.

Referring now to FIG. 12, a diagram of a projection display system including an exit-pupil-forming direct-view display screen to provide higher efficiency into the viewing eyebox and higher uniformity in accordance with one or more embodiments will be discussed. As shown in FIG. 12, projection display system 1200 comprises a scanned beam display projector 100, for example as shown in and described with respect to FIG. 1, which emits a scanned beam 124 toward display screen 210. In the embodiment shown in FIG. 12, display screen 210 comprises an exit-pupil-forming screen that is intended for direct view by a viewer via eyebox 216. The exit cones 1210, 1214, and/or 1216 that are directed toward eyebox 216 such that the exit cones substantially overlap at eyebox 216. In the event display screen 210 does not provide diffusion of the beams of the exit cones, there may be some slight variation in the beam size at the eye plane 1218 due to variations of the scan geometry of scanned beam display projector 100. In some embodiments, such variation in the beam size may be acceptable and/or not noticeable. In one or more particular embodiments, display screen 210 may include a diffuser or diffuser layer in order to diffuse the beam size at the eye plane 1218 to reduce the appearance of coherent tiling artifacts typically caused by such beam size variance. However, these are merely examples of an exit-pupil-forming direct-view display screen 210, and the scope of the claimed subject matter is not limited in these respects.

In one or more embodiments, one or more of the MLAs of the display screen 210 as described herein may have a lenslet pitch selected with respect to a spot size and a beam profile of the incoming beams emitted from the scanned beam projector to reduce tiling artifacts or moiré artifacts, or combinations thereof. For example, the beam profile may comprise a Gaussian profile, a top hat profile, or a rounded top hat profile, and the spot size of the beam may be less than a size of the individual lenslets in the microlens array. Further discussion of such tiling and/or moiré artifact reduction is disclosed in U.S. application Ser. No. 11/963,091 filed Dec. 21, 2007 titled “SCANNED BEAM DISPLAY HAVING HIGH UNIFORMITY AND DIMINISHED COHERENT ARTIFACTS”, inventor Karlton D. Powell. Said application Ser. No. 11/963,091 is hereby incorporated by reference in its entirety.

Although the claimed subject matter has been described with a certain degree of particularity, it should be recognized that elements thereof may be altered by persons skilled in the art without departing from the spirit and/or scope of claimed subject matter. It is believed that the subject matter pertaining to an exit pupil forming scanned beam projection display having higher uniformity and/or many of its attendant utilities will be understood by the forgoing description, and it will be apparent that various changes may be made in the form, construction and/or arrangement of the components thereof without departing from the scope and/or spirit of the claimed subject matter or without sacrificing all of its material advantages, the form herein before described being merely an explanatory embodiment thereof, and/or further without providing substantial change thereto. It is the intention of the claims to encompass and/or include such changes.

What is claimed is:

1. A display screen for a scanned beam display system, comprising:
an exit pupil expander comprising a reflective layer to reflect an incoming beam from a scanned beam projector to an eyebox;
wherein exit numerical aperture cones emanating from the exit pupil expander resulting from the reflected incoming beam are angularly redirected toward an eyebox disposed near a viewing plane to result in substantially overlapping exit bundles, or diffraction patterns, from multiple spots on the exit pupil expander.

2. A display screen for a scanned beam display system as claimed in claim 1, the exit pupil expander having an elliptical profile defined by an ellipsoid wherein the eyebox is disposed at or near a first focus of the ellipsoid and a scanned beam projector is disposed at or near a second focus of the ellipsoid.

3. A display screen for a scanned beam display system as claimed in claim 1, wherein the exit pupil expander is generally planar and comprises a first microlens array and the reflective layer comprising a second microlens array, the second microlens array having a different pitch than the first microlens array and being disposed at a selected distance away from a focal distance of the first microlens array.

4. A display screen for a scanned beam display system as claimed in claim 1, wherein the exit pupil expander is generally planar and comprises a diffuser layer and the reflective layer comprising a prismatic array of array elements.

5. A display screen for a scanned beam display system as clamed in claim 1, wherein the exit pupil expander is generally planar and comprises a first optical medium having a first microlens array formed thereon, and the reflective layer comprising a second optical medium having a second microlens array disposed thereon, the first microlens array having a different pitch than the second microlens array.

6. A display screen for a scanned beam display system as claimed in claim 1, wherein the exit pupil is generally planar and comprises a first optical medium having a microlens array formed thereon, and the reflective layer comprising a second optical medium having a prismatic array, a blazed grating, or a Fresnel reflector, or combinations thereof, disposed thereon, the Fresnel reflector comprising a cylindrical Fresnel reflector, a spherical Fresnel reflector, an anomorphic Fresnel reflector, an aspheric Fresnel reflector, or a reflective grid-faceted Fresnel reflector, or combinations thereof.

7. A display screen for a scanned beam display system as claimed in claim 1, wherein the exit pupil is generally planar and comprises a first optical medium having a random-dimpled diffuser formed thereon, and the reflective layer comprising a prismatic array, a blazed grating, or a Fresnel reflector, or combinations thereof, disposed thereon, the Fresnel reflector comprising a cylindrical Fresnel reflector, a spherical Fresnel reflector, an anomorphic Fresnel reflector, an aspheric Fresnel reflector, or a reflective grid-faceted Fresnel reflector, or combinations thereof.

8. A display system, comprising:
a scanned beam projector to project a scanned beam as a displayed image; and
a display screen, the display screen comprising:
an exit pupil expander comprising a reflective layer to reflect an incoming beam from the scanned beam projector to an eyebox;
wherein exit numerical aperture cones emanating from the exit pupil expander resulting from the reflected incoming beam are angularly redirected toward an eyebox disposed near a viewing plane to result in substantially overlapping exit bundles, or diffraction patterns from multiple spots on the exit pupil expander.

9. A display system as claimed in claim 8, the exit pupil expander having an elliptical profile defined by an ellipsoid wherein the eyebox is disposed at or near a first focus of the ellipsoid and a scanned beam projector is disposed at or near a second focus of the ellipsoid.

10. A display system for a scanned beam projector as claimed in claim 8, wherein the exit pupil expander is generally planar and comprises a first microlens array and the reflective layer comprising a second microlens array, the second microlens array having a different pitch than the first microlens array and being disposed at a selected distance away from a focal distance of the first microlens array.

11. A display system for a scanned beam projector as claimed in claim 8, wherein the exit pupil expander is generally planar and comprises a diffuser layer and the reflective layer comprising a prismatic array of array elements.

12. A display system for a scanned beam projector as clamed in claim 8, wherein the exit pupil expander is generally planar and comprises a first optical medium having a first microlens array formed thereon, and the reflective layer comprising a second optical medium having a second microlens array disposed thereon, the first microlens array having a different pitch than the second microlens array.

13. A display system as claimed in claim 8, wherein the exit pupil is generally planar and comprises a first optical medium having a microlens array formed thereon, and the reflective layer comprising a second optical medium having a prismatic array, a blazed grating, or a Fresnel reflector, or combinations thereof, disposed thereon, the Fresnel reflector comprising a cylindrical Fresnel reflector, a spherical Fresnel reflector, an anomorphic Fresnel reflector, an aspheric Fresnel reflector, or a reflective grid-faceted Fresnel reflector, or combinations thereof.

14. A display system as claimed in claim 8, wherein the exit pupil is generally planar and comprises a first optical medium having a random-dimpled diffuser formed thereon, and the reflective layer comprising a prismatic array, a blazed grating, or a Fresnel reflector, or combinations thereof, disposed thereon, the Fresnel reflector comprising a cylindrical Fresnel reflector, a spherical Fresnel reflector, an anomorphic Fresnel reflector, an aspheric Fresnel reflector, or a reflective grid-faceted Fresnel reflector, or combinations thereof.

15. A display screen for a scanned beam display system, comprising:
a reflective layer capable of reflecting an incoming beam emitted from a scanned beam projector to an eyebox at or near a viewing plane;
wherein exit cones emanating from the reflective layer resulting from the reflected incoming beam are angularly redirected toward the eyebox disposed near a viewing plane to cause the exit cones to substantially overlap at or near the eyebox, and wherein the amount of angular redirection is a function of an X-Y location at which the incoming beam impinges on the reflective layer.

16. A display screen for a scanned beam display system as claimed in claim 15, wherein the exit cones emanate from the reflective layer at little or no angular redirection if the incoming beam has a lower angle of incidence, and the exit cones emanate from the reflective layer at a higher angular redirection if the incoming beam has a higher angle of incidence.

17. A display screen for a scanned beam display system as claimed in claim 15, further comprising a diffuser layer disposed adjacent to the reflective layer to at least partially diffuse the exit cones emanating to the reflective layer or from the reflective layer, or combinations thereof.

18. A display screen for a scanned beam display system as claimed in claim 15, further comprising a microlens array to provide numerical aperture expansion of the exit cones emanating to the reflective layer or from the reflective layer, or combinations thereof.

19. A display screen for a scanned beam display system as claimed in claim 15, further comprising a microlens array to provide numerical aperture expansion of the exit cones emanating to the reflective layer or from the reflective layer, or combinations thereof, wherein the microlens array has a lenslet pitch selected with respect to a spot size and a beamlet profile of the incoming beams emitted from the scanned beam projector to reduce tiling artifacts or moiré artifacts, or combinations thereof.

20. A display screen for a scanned beam display system as claimed in claim 15, wherein the reflective layer comprises a prismatic array, a blazed grating, or a Fresnel reflector, or combinations thereof, disposed thereon, the Fresnel reflector comprising a cylindrical Fresnel reflector, a spherical Fresnel reflector, an anomorphic Fresnel reflector, an aspheric Fresnel reflector, or a reflective grid-faceted Fresnel reflector, or combinations thereof.
